(19) United States
(12) Patent Application Publication
(10) Pub. No.: US 2006/0021493 A1
(43) Pub. Date: Feb. 2, 2006

(54) Drum kit

(76) Inventor: Art Lewis, San Geromino, CA (US)

Correspondence Address: Wendell J. Jones, 555 Bryant Avenue, PMB 441, Palo Alto, CA, 94301, US

(21) Appl. No.: 10/903,739

(22) Filed: Jul. 29, 2004

(51) Int. Cl. G10D 13/02

(52) U.S. Cl. 84/411 R

(57) ABSTRACT

An aspect of the present invention is a drum kit. The drum kit includes a base portion, at least one connecter arm capable of being coupled to the base portion and A plurality of drum pad portions capable of being coupled to the at least one connecter arm wherein each of the plurality of drum pad portion includes a sound reducing material.

### FIELD OF THE INVENTION

The present invention relates generally to musical instruments and more particularly to a drum kit.

### BACKGROUND OF THE INVENTION

Drummers typically find themselves in situations where they would like to warm up or practice in a location where loud noises are objectionable. For example, it is going to be problematic for a drummer living in an apartment complex or a dormitory to practice with a normal drum set due to the loud noise. Another illustration would be a group of students in a school music class where several students are taking drum lessons at the same time. In such cases, it would be desirable for the drummer to practice without making loud drum sounds.

Accordingly, what is needed drumming system that addresses the above outlined issues The drumming system should be simple, inexpensive and capable of being easily adapted to existing technology. The present invention addresses this need.

### SUMMARY OF THE INVENTION

An aspect of the present invention is a drum kit. The drum kit includes a base portion, at least one connecter arm capable of being coupled to the base portion and A plurality of drum pad portions capable of being coupled to the at least one connecter arm wherein each of the plurality of drum pad portion includes a sound reducing material.

Other aspects and advantages of the present invention will become apparent from the following detailed description, taken in conjunction with the accompanying drawings, illustrating by way of example the principles of the invention.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 shows an assembled drum kit in accordance with an embodiment of the present invention.

FIG. 2 is a more detailed illustration of the base portion in accordance with an embodiment of the present invention

FIG. 3 FIG. 3 is a more detailed illustration of the connector arm in accordance with an embodiment of the present invention

FIG. 4 is a more detailed illustration of a drum pad portion in accordance with an embodiment of the present invention.

FIG. 5 is a more detailed illustration of another drum pad portion in accordance with an embodiment of the present invention.

### DETAILED DESCRIPTION

The present invention includes a drum kit. The following description is presented to enable one of ordinary skill in the art to make and use the invention and is provided in the context of a patent application and its requirements. Various modifications to the embodiments and the generic principles and features described herein will be readily apparent to those skilled in the art. Thus, the present invention is not intended to be limited to the embodiment shown but is to be accorded the widest scope consistent with the principles and features described herein.

The present invention comprises a drum kit. In an embodiment, the drum kit is designed to be fully adjustable and incorporates sound reducing elements. Accordingly, a drummer can practice her craft in locations where loud noises are objectionable (apartments, dormitories, etc.).

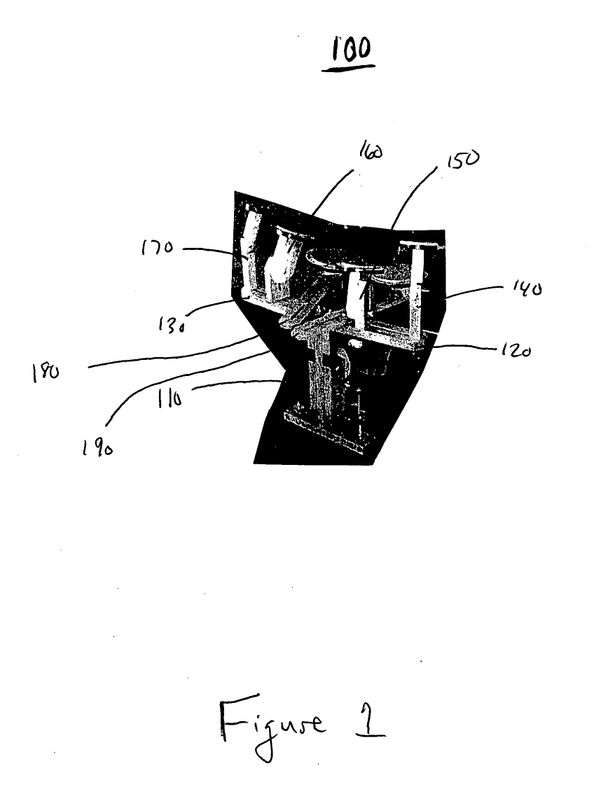

FIG. 1 shows an assembled drum kit 100 in accordance with an embodiment of the present invention. The drum kit 100 includes a base portion 110, two connector arms 120, 130 and a plurality of drum pad portions 140-190. The connector arms 120, 130 are coupled to the base portion 110 and the plurality of drum pad portions 140-190 are coupled to the connector arms 120, 130.

In an embodiment, the base portion 110, the two connector arms 120, 130 and the plurality of drum pad portions 140-190 are comprised of a wood material. However, one of ordinary skill in the art will readily recognize that a variety of different materials could be utilized while remaining within the spirit and scope of the present invention.

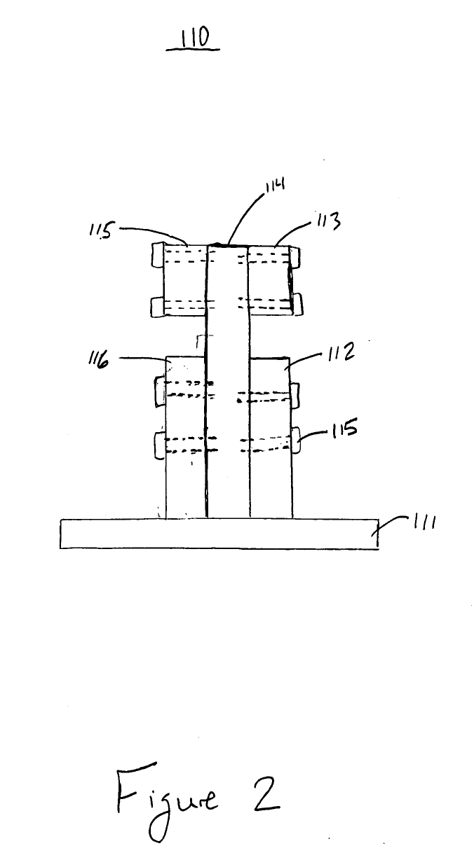

FIG. 2 is a more detailed illustration of the base portion 110. The base portion 110 includes a bottom piece 111 coupled to a central piece 114. The base portion 110 also includes bottom stabilizing elements 112, 116 and top stabilizing elements 113, 115. In an embodiment, both the bottom stabilizing elements 112, 116 and the top stabilizing elements 113, 115 are coupled to the central piece 114 via securing bolts 115. However, one of ordinary skill in the art will readily recognize the stabilizing elements 112, 113, 115, 116 could be coupled to the central piece 114 via a strong adhesive or any of a variety of other means while remaining within the spirit and scope of the present invention.

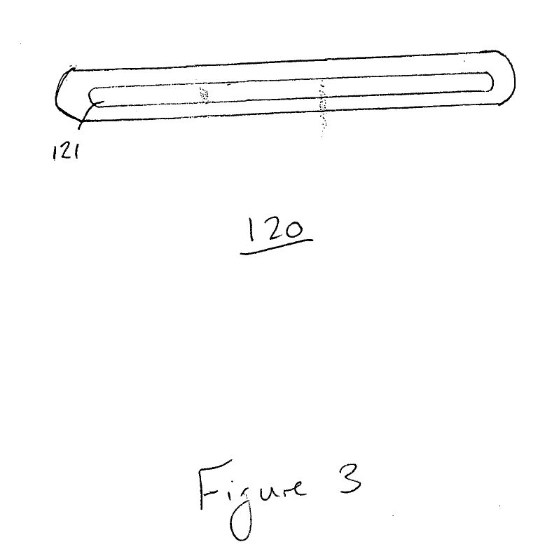

FIG. 3 is a more detailed illustration of the connector arm 120. It should be understood that the described connector arm 120 is similar to the connector arm 130. The connector arm 120 includes a slit 121. The slit 121 allows the connector arm 120 to be connected to either one of the top stabilizing elements 113, 115 (See FIG. 2) via a removable bolt (not shown) or similar adjustable connection means. Accordingly, the connector arm 120 can be slidably adjusted based on the physical characteristics of the user by removing the bolt, slidably adjusting the connector arm 120 and re-attaching the bolt.

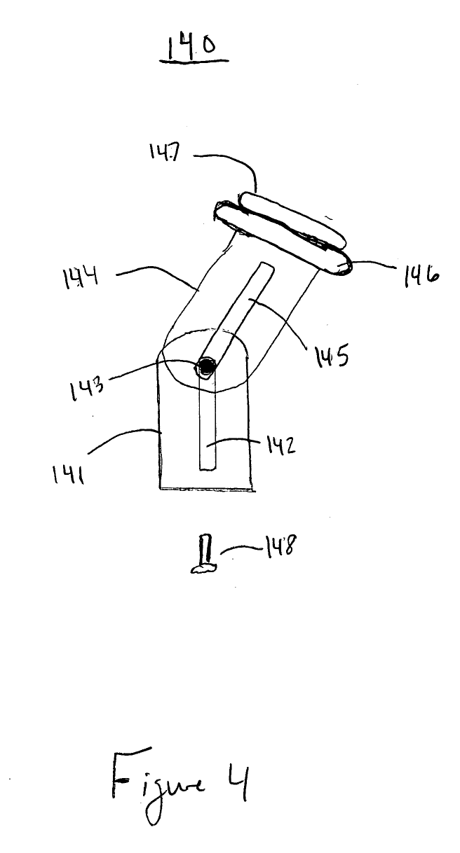

FIG. 4 is a more detailed illustration of the drum pad portion 140. It should be understood that the described drum pad portion 140 is similar to the drum pad portions 150-170. The drum pad portion 140 includes a first piece 141 and a second piece 144 wherein the first and second pieces 141, 144 respectively include slits 142, 145. The first and second pieces 141, 144 are coupled together via a removable bolt 143. Accordingly, the first and second pieces 141, 144 are capable of being slidably adjusted via the slits 142, 145 by loosening the bolt 143 and slidably adjusting the first and second pieces 141, 144.

The drum pad portion 140 further includes a support element 146 and a sound reducing element 147 wherein the support element 146 is coupled to the second piece 144 and the sound reducing element 147 is coupled to the support element 146. The sound reducing element 147 is a soft, pad-like material that when struck by a drum stick, generates a low (under 3 decibel) sound. In an embodiment, the soft, pad-like material is gum rubber or the like. The drum pad portion 140 is capable of being slidably coupled to either one of the connector arms 120, 130 (see FIG. 1) via a mounting bolt 148.

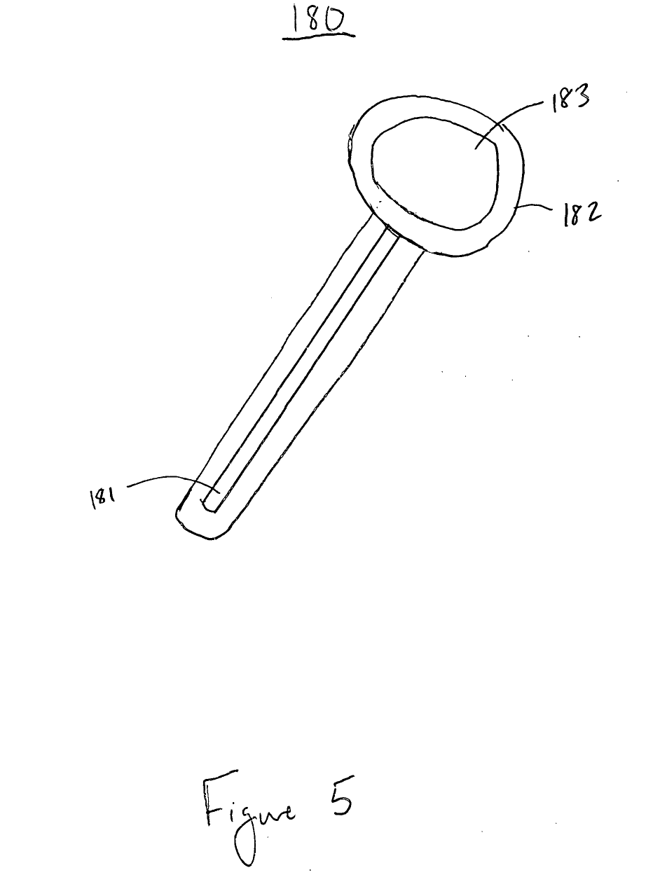

FIG. 5 is a more detailed illustration of the drum pad portion 180. It should be understood that the described drum pad portion 180 is similar to the drum pad portion 190. These drum pad portions can be referred to as central drum pad portion. Central drum pad portion 180 includes a slit 181, a support element 182 and a soft, pad like sound reducing element 183. The support element 182 is coupled via a removable securing bolt (not shown) and the sound reducing element 183 is coupled to the support element 182 via an adhesive or other suitable means. The slit 181 allows the central drum pad portion 180 to be slidably connected to either one of the connector arms 120, 130 (see FIG. 1) via a mounting bolt (not shown). Additionally, the slit 181 allows the support element 182 to be slidably adjusted by a user thereby increasing the flexibility of the drum kit.

A drum kit is disclosed. In an embodiment, the drum kit is designed to be fully adjustable and incorporates sound reducing elements. Accordingly, a drummer can practice her craft in locations where loud noises are objectionable (apartments, dormitories, etc.). Additionally, since the drum kit includes detachable pieces, the drum kit can be easily disassembled and stored away for later use.

Without further analysis, the foregoing so fully reveals the gist of the present invention that others can, by applying current knowledge, readily adapt it for various applications without omitting features that, from the standpoint of prior art, fairly constitute essential characteristics of the generic or specific aspects of this invention. Therefore, such applications should and are intended to be comprehended within the meaning and range of equivalents of the following claims. Although this invention has been described in terms of certain embodiments, other embodiments that are apparent to those of ordinary skill in the art are also within the scope of this invention, as defined in the claims that follow.

1. A drum kit comprising:
a base portion;
at least one connecter arm capable of being coupled to the base portion;
a plurality of drum pad portions capable of being coupled to the at least one connecter arm wherein each of the plurality of drum pad portion includes a sound reducing material; and
wherein the at least one connector arm comprises a slit and each of the plurality of drum pad portions are capable of being slidably adjusted via the slit.

2. The drum kit of claim 1 wherein the sound reducing material comprises gum rubber.

3. The drum kit of claim 1 wherein the base portion, the at least one connector arm and each of the plurality of drum pad portions are comprised of a wood material.

4. The drum kit of claim 1 wherein at least one of the plurality of drum pad portions comprises:
a first piece including a first slit;
a second piece including a second slit wherein the first piece and the second piece are capable of being coupled together via a removable bolt;
a support element coupled to the second piece; and
a soft, rubber-like material coupled to the support element.

5. (canceled)

6. The drum kit of claim 4 1 wherein the at least one of the plurality of drum pad portions wherein the first and second pieces are capable of being slidably connected to each other via the first and second slits.

7. The drum kit of claim 4 1 wherein another of the plurality of drum pad portions comprises a central drum pad portion.

8-10. (canceled)

11. A drum kit comprising:
a base portion wherein the base portion includes at least two stabilizing elements;
two connector arms capable of being slidably coupled to one of the at least two stabilizing elements;
six drum pad portions capable of being coupled to one of the two connector arms wherein two of the six drum pad portions are central drum pad portions and each of the other of the six drum pad portions comprises:
a first piece including a first slit;
a second piece including a second slit wherein the first piece and the second piece are capable of being coupled together via a removable bolt;
a support element coupled to the second piece; and
a gum rubber material coupled to the support element;
wherein the two connector arms respectively comprise a slit for the slidable adjustment of the six drum pad portions.
